(19) United States
(12) Patent Application Publication
(10) Pub. No.: US 2026/0121960 A1
(43) Pub. Date: Apr. 30, 2026

(54) FIFTH GENERATION (5G) STANDALONE (SA) UTILIZATION METRIC IN WIRELESS COMMUNICATION NETWORKS

(71) Applicant: T-Mobile USA, Inc., Bellevue, WA (US)

(72) Inventors: Sang Yoon Yang, Maple Valley, WA (US); Baquer Ali Chabuk Savar, Auburn, WA (US); Amembal Vikram Pai, Bothell, WA (US)

(21) Appl. No.: 18/930,708

(22) Filed: Oct. 29, 2024

(51) Int. Cl. H04L 43/0882; H04W 16/18; H04W 24/02

(52) U.S. Cl. CPC H04L 43/0882; H04W 16/18; H04W 24/02

(57) ABSTRACT

Techniques and architecture described herein provide a 5G SA utilization metric that addresses the need for a precise metric to gauge the adoption and utilization of 5G SA across both networks and devices. The 5G SA utilization metric is derived by distinguishing 5G SA traffic from other types of traffic within a wireless communication network based on radio access technology (RAT) type and calculating the ratio of 5G SA traffic to total traffic within the wireless communication network and expressing it as a percentage. The 5G SA utilization metric provides a critical measure of 5G SA utilization within the wireless communication network and is extremely useful for assessing network performance, guiding expansion and optimization efforts, and verifying device 5G SA usage within the wireless communication network to correlate with user experience.

### BACKGROUND

The telecommunications industry is transitioning towards the fifth generation (5G) standalone (SA) configured network, which is a fully independent 5G architecture that offers significant advantages such as low latency high data rates, enhanced reliability, massive Internet-of-Things (IOT) connectivity. Thus, there is a growing need for a precise metric to gauge the adoption and utilization of 5G SA across both networks and devices. Currently, there is a lack of a comprehensive metric to measure and monitor the progress of adoption and utilization of 5G SA across both networks and devices. This represents a significant challenge. For example, currently, there is no effective way to identify gaps across both the network side and the device side. Additionally, there is no effective way to support the necessary network upgrades and optimizations. This is slowing down deployment efforts for 5G SA and hindering full scale network performance improvements.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 schematically illustrates an example block diagram of an architecture for a portion of a wireless communication network that evaluates one or more 5G SA focus areas using the 5G SA utilization metric, according to some implementations.

FIG. 2 is a flow diagram illustrating an example method for calculating a 5G SA utilization metric and evaluating one or more 5G SA focus areas using the 5G SA utilization metric, according to some implementations.

FIG. 3 schematically illustrates a component level view of an example mobile communication device configured for use with the techniques and architecture described herein, according to some implementations.

FIG. 4 schematically illustrates a component level view of a server configured for use with the techniques and architecture described herein, according to some implementations.

### DETAILED DESCRIPTION

Described herein are techniques and architecture that provide a 5G SA utilization metric that addresses the need for a precise metric to gauge the adoption and utilization of 5G SA across both networks and devices. More particularly, the techniques and architecture described herein provide a 5G SA utilization metric that captures all data traffic from a packet data network gateway (PGW) of a wireless communication network and/or a user plane function (UPF) (converged core). The 5G SA utilization metric is derived by distinguishing 5G SA traffic from other types of traffic within a wireless communication network based on radio access technology (RAT) type and calculating the ratio of 5G SA traffic to total traffic within the wireless communication network and expressing it as a percentage. This 5G SA utilization metric provides a critical measure of 5G SA utilization within the wireless communication network. The 5G SA utilization metric is extremely useful for assessing network performance, guiding expansion and optimization efforts, and verifying device 5G SA usage within the wireless communication network to correlate with user experience. The 5G SA utilization metric supports the telecommunication industry's shift toward to a 5G SA centric future, achieving milestones, for example, national 5G SA utilization of 50 percent or more, enabling over 82 million mobile devices with SA capabilities, and driving nationwide 5G SA expansion.

More particularly, the 5G SA utilization metric provides actual insights by tracking the progress of 5G SA deployment, identifying network level and device level inefficiencies, and guiding targeted upgrade strategies. The 5G SA utilization metric serves as a key enabler in streamlining the transition to 5G SA, accelerating optimization, and ultimately ensuring the delivery of unparalleled 5G SA user experience.

The 5G SA utilization metric helps drive key focus areas to improve user experience through 5G SA usage within the wireless communication network. For example, based on the 5G SA utilization metric, one or more 5G SA focus areas may be evaluated. For example, layer management strategies for 5G SA within wireless communication networks may be evaluated to help guide traffic steering optimization. As an additional example, the 5G SA utilization metric may be used to help in evaluating infra vendor benchmarking in order to help drive features and functionalities to grow and steer traffic toward 5G SA within wireless communications networks.

Also, as a further example, the 5G SA utilization metric may be used to help evaluate device performance and thereby drive original equipment manufacturer (OEM), device and chip vendors to fix and improve technology issues with respect to 5G SA. As a further example, the 5G SA utilization metric may be used to help evaluate operational efficiencies with respect to 5G SA and thereby help with overall operation efficiency, tracking resource consumption, and identifying areas for optimization. Also, as an additional example, the 5G SA utilization metric may be utilized to help evaluate asset management by helping measure, track, and drive spectrum asset usage and plan of record prioritization. The 5G SA utilization metric may also help drive wireless communication strategies. Also, the 5G SA utilization metric may help in evaluating and improving user experience by assessing and driving user experience based on 5G SA utilization cohorts.

Accordingly, as an example, a method comprises collecting, by a controller within a wireless communication network from at least one source within the wireless communication network, data related to total traffic within the wireless communication network. The method also comprises classifying, by the controller, the data based on radio access technology (RAT) type and based at least in part on the RAT type, identifying, by the controller, an amount of traffic of the total traffic attributable to fifth generation (5G) standalone (SA) RAT type. The method further comprises determining, by the controller, a 5G SA utilization metric, wherein determining the 5G SA utilization metric comprises dividing the total traffic by the amount of traffic attributable to the 5G SA RAT type. The method additionally comprises based at least in part on the 5G SA utilization metric, evaluating one or more 5G SA focus areas.

In configurations, the at least one source comprises one or more of (i) a packet data network gateway (PGW) of the wireless communication network or (ii) a user plane function (UPF) of the wireless communication network.

In some configurations, the one or more 5G SA focus areas comprise optimization of national 5G SA utilization.

In configurations, the one or more 5G SA focus areas comprise mobile device vendor 5G SA utilization.

In some configurations, the one or more 5G SA focus areas comprise mobile device operating system (OS) 5G SA utilization.

In configurations, the one or more 5G SA focus areas comprise mobile device design.

In some configurations, the one or more 5G SA focus areas comprise 5G SA deployment within the wireless communication network.

In configurations, the one or more 5G SA focus areas comprise identifying one or more network inefficiencies or one or more mobile device inefficiencies.

In some configurations, the one or more 5G SA focus areas comprise guiding targeted upgrade strategies within the wireless communication network.

As another example, a system comprises one or more processors; and one or more non-transitory computer-readable media storing computer-executable instructions that, when executed by the one or more processors, cause the one or more processors to perform actions. The actions comprise collecting, by a controller within a wireless communication network from at least one source within the wireless communication network, data related to total traffic within the wireless communication network. The actions also comprise classifying, by the controller, the data based on radio access technology (RAT) type and based at least in part on the RAT type, identifying, by the controller, an amount of traffic of the total traffic attributable to fifth generation (5G) standalone (SA) RAT type. The actions further comprise determining, by the controller, a 5G SA utilization metric, wherein determining the 5G SA utilization metric comprises dividing the total traffic by the amount of traffic attributable to the 5G SA RAT type. The actions additionally comprise based at least in part on the 5G SA utilization metric, evaluating one or more 5G SA focus areas.

Thus, the techniques and architecture described herein provide a 5G SA utilization metric that addresses the need for a precise metric to gauge the adoption and utilization of 5G SA across both networks and devices. More particularly, the techniques and architecture described herein provide a 5G SA utilization metric that captures all data traffic from a packet data network gateway (PGW) of a wireless communication network and a user plane function (UPF) (converged core). The 5G SA utilization metric is derived by distinguishing 5G SA traffic from other types of traffic within a wireless communication network based on radio access technology (RAT) type and calculating the ratio of 5G SA traffic to total traffic within the wireless communication network and expressing it as a percentage. This 5G SA utilization metric provides a critical measure of 5G SA utilization within the wireless communication network. The 5G SA utilization metric is extremely useful for assessing network performance, guiding expansion and optimization efforts, and verifying device 5G SA usage within the wireless communication network to correlate with user experience. The 5G SA utilization metric supports the telecommunication industry's shift toward to a 5G SA centric future, achieving milestones, for example, national 5G SA utilization of 50 percent or more, enabling over 82 million mobile devices with SA capabilities, and driving nationwide 5G SA expansion. More particularly, the 5G SA utilization metric provides actual insights by tracking the progress of 5G SA deployment, identifying network level and device level inefficiencies, and guiding targeted upgrade strategies. The 5G SA utilization metric serves as a key enabler in streamlining the transition to 5G SA, accelerating optimization, and ultimately ensuring the delivery of unparalleled 5G SA user experience.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

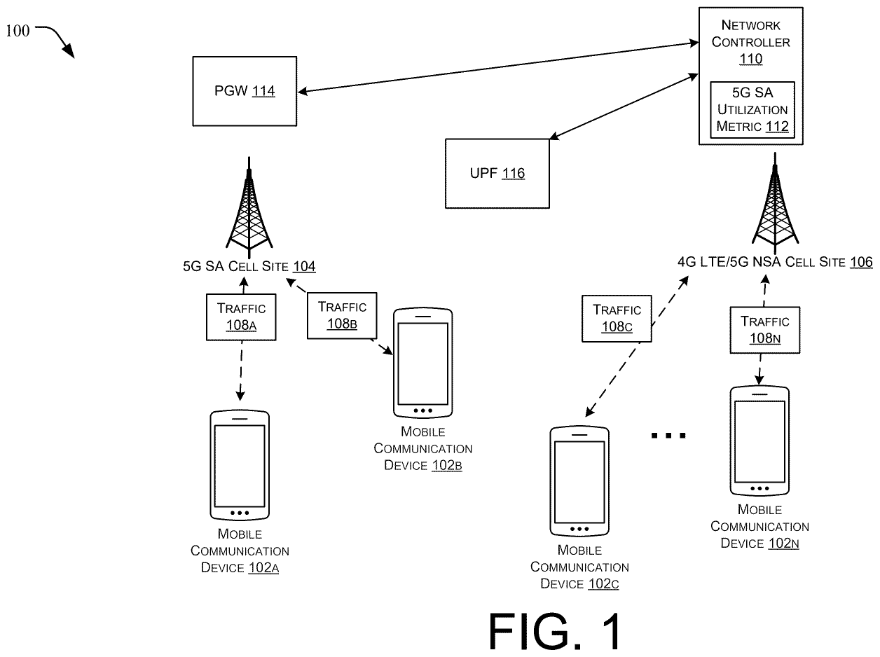

FIG. 1 schematically illustrates an example portion of a wireless communication network 100. Mobile communication devices 102a-102n, e.g., a smart phone, a television, a smart appliance (e.g., an Internet of Things (IoT) device), a laptop, a tablet, a personal computer, etc., is configured to operate within the wireless communication network 100. At least the mobile communication device 102a is configured to operate at least in accordance with 5G SA protocol.

In configurations, mobile communication devices 102 may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the mobile communication devices 102 as being “mobile” (i.e., configured to be carried and moved around), it is to be appreciated that the mobile communication devices 102 may represent various types of communication devices that are generally stationary as well, such as televisions, desktop computers, game consoles, set top boxes, Internet of Things (IoT) devices, and the like. In this sense, the terms “communication device,” “wireless device,” “wireline device,” “mobile communication device,” “mobile device,” “computing device,” “portable electronic device,” and “user equipment (UE)” may be used interchangeably herein to describe any communication device capable of performing the techniques described herein.

Furthermore, in addition to 5G SA, the portable mobile communication devices 102 may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), 4G Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VoLTE), 5G, IEEE 802.1x protocols, WiMAX, Wi-Fi, and/or any future IP-based network technology or evolution of an existing IP-based network technology.

The wireless communication network 100 includes a 5G SA cell site (base station) 104 and a 4G LTE/5G NSA base station 106. The mobile communication devices 102a and 102b are configured to operate at least in accordance with the 5G SA protocol via data traffic 108a and 108b, respectively. The other mobile devices 102c-102n are configured to operate at least in accordance with the 5G NSA protocol via data traffic 108c-108n, respectively, and may or may not be configured to operate in accordance with the 5G SA protocol.

As is known, when 5G was first introduced into wireless communication network architecture, non-standalone (NSA) 5G was first used. NSA is a 5G radio access network (RAN) that operates on a legacy 4G LTE core, known as Evolved Packet Core (EPC), and manages control plane functions. 5G NSA includes both a 4G and 5G base station, but the 4G base station takes precedence. Because the new radio (NR) control plane anchors to EPC, radio frequency signals forward to the primary 4G base station.

5G NSA, also known as Release 15 by 3GPP, is considered the first stage of 5G. Initial 5G deployments used NSA because wireless communication network operators could use their current infrastructure to build a 5G network. Wireless communication networks with 4G LTE networks could implement a 5G RAN on top of their existing architectures. 5G NSA can serve as a steppingstone for wireless communication networks unprepared to make a hefty investment when they transition from legacy 4G LTE to 5G networks.

The drawback of 5G NSA, however, is it cannot deliver certain capabilities that a pure, unfettered 5G SA network can. For example, NSA does not enable the low latency that is one of the biggest draws to 5G. Another disadvantage of NSA is it requires a higher level of energy to power 5G networks with 4G infrastructure. 5G NR is generally more energy-efficient than LTE, but using two different forms of cellular technology massively increases power consumption in a network.

5G NSA also should not be mistaken for dynamic spectrum sharing (DSS), another method of deploying 5G with 4G technology. While NSA creates a 5G network with 4G infrastructure using dual connectivity, DSS permits 4G LTE and 5G NR to coexist in the same frequency band. 5G networks have a variety of spectrum bands available for use, and DSS distributes spectrum between bands based on user demands.

5G SA networks include both a 5G RAN and a cloud-native 5G core, something 5G NSA networks lack and substitute with a 4G core. Because 5G SA networks have 5G cores, the 5G SA network can perform essential 5G functions and offer advantages like reduced latency, improved network performance and the ability to control network management functions with a central controller.

5G SA requires wireless communication network operators to configure a completely new architecture and learn how to manage it. As wireless communication network operators waited for 5G SA technology to mature, most opted to simply reconfigure their 4G networks to support 5G, as it was cheaper and more convenient.

New wireless communication network operators without established 4G core networks could not follow that strategy though. Because such wireless communication network operators could not rely on a 4G core, the wireless communication network operators needed to build their 5G infrastructure from scratch. 5G SA could soon take the crown among wireless communication network operators, as wireless communication network operators start to deploy it to take advantage of the improvements it offers over NSA.

The biggest disadvantage of 5G SA is it is costly to implement and time-consuming for network professionals to learn the new 5G core infrastructure. Regardless, it is likely that wireless communication network operators will eventually make the shift to SA because, while NSA can serve as a step toward 5G networking, it isn't considered true 5G due to its reliance on 4G LTE.

A network controller 110 of the wireless communication network 100 gathers data related to data traffic 108a-108n to calculate a 5G SA utilization metric 112 that addresses the need for a precise metric to gauge the adoption and utilization of 5G SA across both the wireless communication network 100 and mobile communication devices 102. The network controller 110 captures all data traffic from one or both of a packet data network gateway (PGW) 114 of the wireless communication network 100 and a user plane function (UPF) (converged core) 116 of the wireless communication network 100. The 5G SA utilization metric is derived by distinguishing 5G SA traffic, e.g., data traffic 108a and 108b from other types of traffic, e.g., traffic 108c-108n within the wireless communication network 100 based on radio access technology (RAT) type and calculating the ratio of 5G SA traffic (data traffic 108a and 108b) to total traffic (data traffic 108a-108n) within the wireless communication network 100 and expressing it as a percentage.

Thus, in configurations, the 5G SA utilization metric 112 metric logic used by the network controller 110 comprises (i) data collection in the form of data traffic from PGW 114/UPF 116 (edge demand response (EDR)), (ii) RAT type classification, which identifies 5G SA traffic (RAT_TYPE=51), and (iii) utilization calculation, which may be represented by EDR 5G SA Bytes (Upload+Download) as a percentage of EDR Total Bytes, with a formula of (sum(EDR_5G_SA_BYTES)/sum (EDR_TOTAL_BYTES))*100.

This 5G SA utilization metric 112 provides a critical measure of 5G SA utilization within the wireless communication network 100. The 5G SA utilization metric 112 is extremely useful for assessing network performance, guiding expansion and optimization efforts, and verifying device 5G SA usage within the wireless communication network to correlate with user experience. The 5G SA utilization metric 112 supports the telecommunication industry's shift toward to a 5G SA centric future, achieving milestones, for example, national 5G SA utilization of 50 percent or more, enabling over 82 million mobile devices with SA capabilities, and driving nationwide 5G SA expansion.

More particularly, the 5G SA utilization metric 112 provides actual insights by tracking the progress of 5G SA deployment, identifying network level and device level inefficiencies, and guiding targeted upgrade strategies. The 5G SA utilization metric 112 serves as a key enabler in streamlining the transition to 5G SA, accelerating optimization, and ultimately ensuring the delivery of unparalleled 5G SA user experience.

The 5G SA utilization metric 112 helps drive key focus areas to improve user experience through 5G SA usage within the wireless communication network 100. For example, based on the 5G SA utilization metric 112, one or more 5G SA focus areas may be evaluated. For example, layer management strategies for 5G SA within the wireless communication network 100 may be evaluated to help guide traffic steering optimization. As an additional example, the 5G SA utilization metric 112 may be used to help in evaluating infra vendor benchmarking in order to help drive features and functionalities to grow and steer traffic toward 5G SA within the wireless communications network 100. Also, as a further example, the 5G SA utilization metric 112 may be used to help evaluate device performance and thereby drive original equipment manufacturers (OEMs) of mobile communication devices 102, mobile communication device 102 and chip vendors to fix and improve technology issues with respect to 5G SA.

As a further example, the 5G SA utilization metric 112 may be used to help evaluate operational efficiencies with respect to 5G SA and thereby help with overall operation efficiency, tracking resource consumption, and identifying areas for optimization. Also, as an additional example, the 5G SA utilization metric 112 may be utilized to help evaluate asset management by helping measure, track, and drive spectrum asset usage and plan of record prioritization. The 5G SA utilization metric 112 may also help drive wireless communication strategies. Also, the 5G SA utilization metric 112 may help in evaluating and improving user experience by assessing and driving user experience based on 5G SA utilization cohorts.

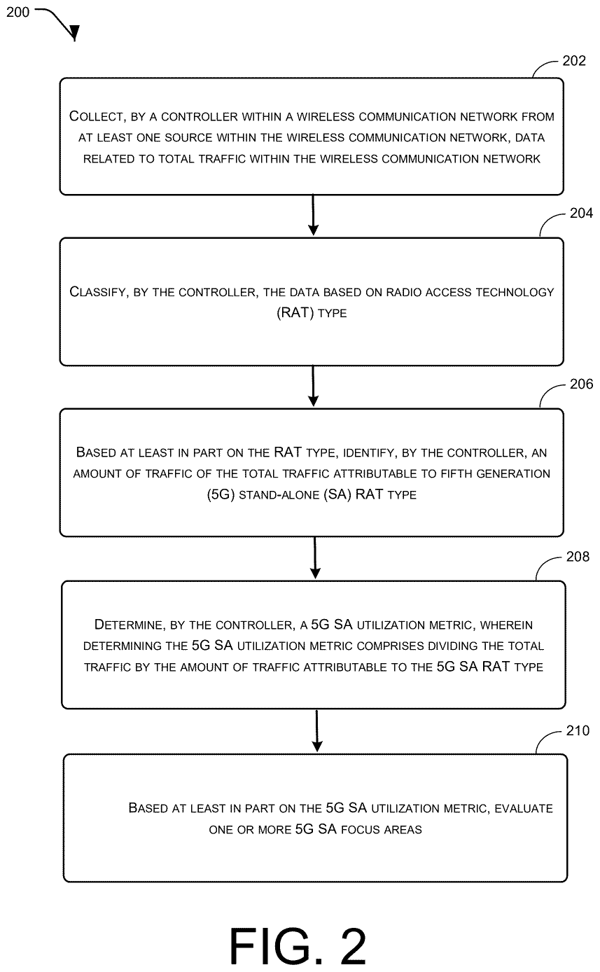

FIG. 2 is a flow diagram illustrating an example method for calculating a 5G SA utilization metric, e.g., 5G SA utilization metric 112, and evaluating one or more 5G SA focus areas using the 5G SA utilization metric. The process is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

At 202, a controller within a wireless communication network collects, from at least one source within the wireless communication network, data related to total traffic within the wireless communication network. At 204, the controller classifies the data based on radio access technology (RAT) type. For example, the network controller 110 of the wireless communication network 100 gathers data related to data traffic 108a-108n to calculate a 5G SA utilization metric 112 that addresses the need for a precise metric to gauge the adoption and utilization of 5G SA across both the wireless communication network 100 and mobile communication devices 102. The network controller 110 captures all data traffic from one or both of a packet data network gateway (PGW) 114 of the wireless communication network 100 and a user plane function (UPF) (converged core) 116 of the wireless communication network 100.

At 206, based at least in part on the RAT type, the controller identifies an amount of traffic of the total traffic attributable to fifth generation (5G) stand-alone (SA) RAT type. At 208, the controller determines a 5G SA utilization metric, wherein determining the 5G SA utilization metric comprises dividing the total traffic by the amount of traffic attributable to the 5G SA RAT type. For example, the 5G SA utilization metric is derived by distinguishing 5G SA traffic, e.g., data traffic 108a and 108b from other types of traffic, e.g., traffic 108c-108n within the wireless communication network 100 based on radio access technology (RAT) type and calculating the ratio of 5G SA traffic (data traffic 108a and 108b) to total traffic (data traffic 108a-108n) within the wireless communication network 100 and expressing it as a percentage.

Thus, in configurations, the 5G SA utilization metric 112 metric logic used by the network controller 110 comprises (i) data collection in the form of data traffic from PGW 114/UPF 116 (edge demand response (EDR)), (ii) RAT type classification, which identifies 5G SA traffic (RAT_TYPE=51), and (iii) utilization calculation, which may be represented by EDR 5G SA Bytes (Upload+Download) as a percentage of EDR Total Bytes, with formula of: (sum(EDR_5G_SA_BYTES)/sum(EDR_TOTAL_BYTES))*100.

At 210, based at least in part on the 5G SA utilization metric, one or more 5G SA focus areas are evaluated. For example, the 5G SA utilization metric 112 provides a critical measure of 5G SA utilization within the wireless communication network 100. The 5G SA utilization metric 112 is extremely useful for assessing network performance, guiding expansion and optimization efforts, and verifying device 5G SA usage within the wireless communication network to correlate with user experience. The 5G SA utilization metric 112 supports the telecommunication industry's shift toward to a 5G SA centric future, achieving milestones, for example, national 5G SA utilization of 50 percent or more, enabling over 82 million mobile devices with SA capabilities, and driving nationwide 5G SA expansion.

More particularly, the 5G SA utilization metric 112 provides actual insights by tracking the progress of 5G SA deployment, identifying network level and device level inefficiencies, and guiding targeted upgrade strategies. The 5G SA utilization metric 112 serves as a key enabler in streamlining the transition to 5G SA, accelerating optimization, and ultimately ensuring the delivery of unparalleled 5G SA user experience.

The 5G SA utilization metric 112 helps drive key focus areas to improve user experience through 5G SA usage within the wireless communication network 100. For example, based on the 5G SA utilization metric 112, one or more 5G SA focus areas may be evaluated. For example, layer management strategies for 5G SA within the wireless communication network 100 may be evaluated to help guide traffic steering optimization. As an additional example, the 5G SA utilization metric 112 may be used to help in evaluating infra vendor benchmarking in order to help drive features and functionalities to grow and steer traffic toward 5G SA within the wireless communications network 100. Also, as a further example, the 5G SA utilization metric 112 may be used to help evaluate device performance and thereby drive original equipment manufacturers (OEMs) of mobile communication devices 102, mobile communication device 102 and chip vendors to fix and improve technology issues with respect to 5G SA. As a further example, the 5G SA utilization metric 112 may be used to help evaluate operational efficiencies with respect to 5G SA and thereby help with overall operation efficiency, tracking resource consumption, and identifying areas for optimization. Also, as an additional example, the 5G SA utilization metric 112 may be utilized to help evaluate asset management by helping measure, track, and drive spectrum asset usage and plan of record prioritization. The 5G SA utilization metric 112 may also help drive wireless communication strategies. Also, the 5G SA utilization metric 112 may help in evaluating and improving user experience by assessing and driving user experience based on 5G SA utilization cohorts.

Thus, the techniques and architecture described herein provide a 5G SA utilization metric that addresses the need for a precise metric to gauge the adoption and utilization of 5G SA across both networks and devices. More particularly, the techniques and architecture described herein provide a 5G SA utilization metric that captures all data traffic from a packet data network gateway (PGW) of a wireless communication network and a user plane function (UPF) (converged core). The 5G SA utilization metric is derived by distinguishing 5G SA traffic from other types of traffic within a wireless communication network based on radio access technology (RAT) type and calculating the ratio of 5G SA traffic to total traffic within the wireless communication network and expressing it as a percentage. This 5G SA utilization metric provides a critical measure of 5G SA utilization within the wireless communication network. The 5G SA utilization metric is extremely useful for assessing network performance, guiding expansion and optimization efforts, and verifying device 5G SA usage within the wireless communication network to correlate with user experience. The 5G SA utilization metric supports the telecommunication industry's shift toward to a 5G SA centric future, achieving milestones, for example, national 5G SA utilization of 50 percent or more, enabling over 82 million mobile devices with SA capabilities, and driving nationwide 5G SA expansion. More particularly, the 5G SA utilization metric provides actual insights by tracking the progress of 5G SA deployment, identifying network level and device level inefficiencies, and guiding targeted upgrade strategies. The 5G SA utilization metric serves as a key enabler in streamlining the transition to 5G SA, accelerating optimization, and ultimately ensuring the delivery of unparalleled 5G SA user experience.

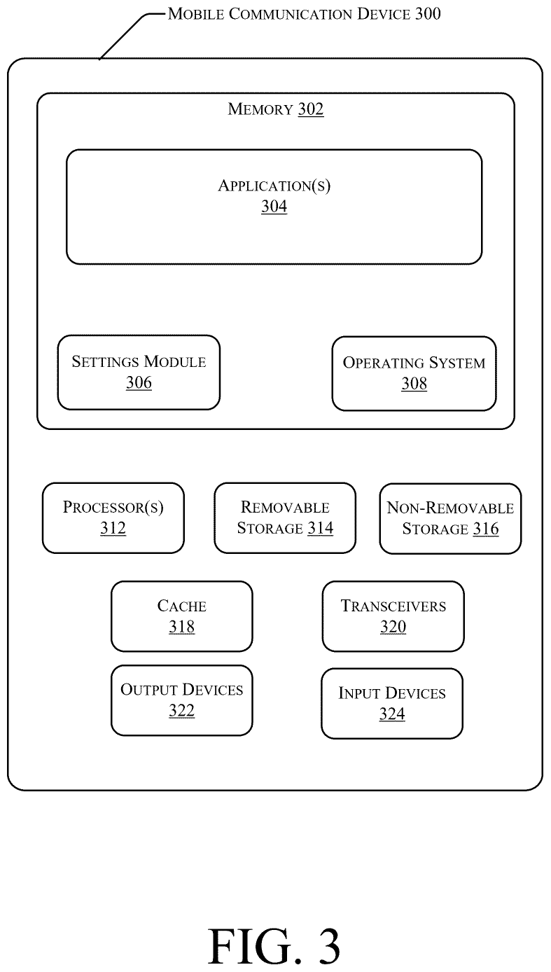

FIG. 3 schematically illustrates a component level view of a mobile communication device 300, such as mobile communication devices 102, configured to function within wireless communication networks. As illustrated, the mobile communication device 300 comprises a system memory 302, e.g., computer-readable media, storing application(s) 304. Alternatively, the functions and UIs may be implemented, wholly or in part, via firmware (not illustrated). The mobile communication device 300 also comprises a settings module 306, and an operating system 308. Also, the mobile communication device 300 includes processor(s) 312, a removable storage 314, a non-removable storage 316, cache 318, transceivers 320, output device(s) 322, and input device(s) 324. In various implementations, system memory 302 is volatile (such as RAM), non-volatile (such as ROM, flash memory, etc.) or some combination of the two. In some implementations, the processor(s) 312 is a central processing unit (CPU), a graphics processing unit (GPU), or both CPU and GPU, or any other sort of processing unit.

The mobile communication device 300 may also include additional data storage devices (removable and/or non-removable) such as, for example, magnetic disks, optical disks, or tape. Such additional data storage may include removable storage 314 and non-removable storage 316. Additionally, the mobile communication device 300 includes cache 318.

Non-transitory computer-readable media may include volatile and nonvolatile, removable and non-removable tangible, physical media implemented in technology for storage of information, such as computer readable instructions, data structures, program modules, or other data. System memory 302, removable storage 314, non-removable storage 316 and cache 318 are all examples of non-transitory computer-readable media. Non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information and which can be accessed by the mobile communication device 300. Any such non-transitory computer-readable media may be part of the mobile communication device 300. The processor(s) 312 may be configured to execute instructions, which may be stored in the non-transitory computer-readable media or in other computer-readable media accessible to the processor(s) 312.

In some implementations, the transceivers 320 include any sort of transceivers known in the art. For example, the transceivers 320 may include a radio transceiver that performs the function of transmitting and receiving radio frequency communications via an antenna (not shown). Also, or alternatively, the transceivers 320 may include wireless modem(s) to facilitate wireless connectivity with other computing devices. Further, the transceivers 320 may include wired communication components, such as an Ethernet port, for communicating with other networked devices.

In some implementations, the output devices 322 include any sort of output devices known in the art, such as a display (e.g., a liquid crystal display), speakers, a vibrating mechanism, or a tactile feedback mechanism. Output devices 322 also include ports for one or more peripheral devices, such as headphones, peripheral speakers, or a peripheral display.

In various implementations, input devices 324 include any sort of input devices known in the art. For example, input devices 324 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 324 may be used to enter preferences of a user of the mobile communication device 300 to define how the user wishes certain calls from third parties to be handled by the wireless communication network, as previously described herein.

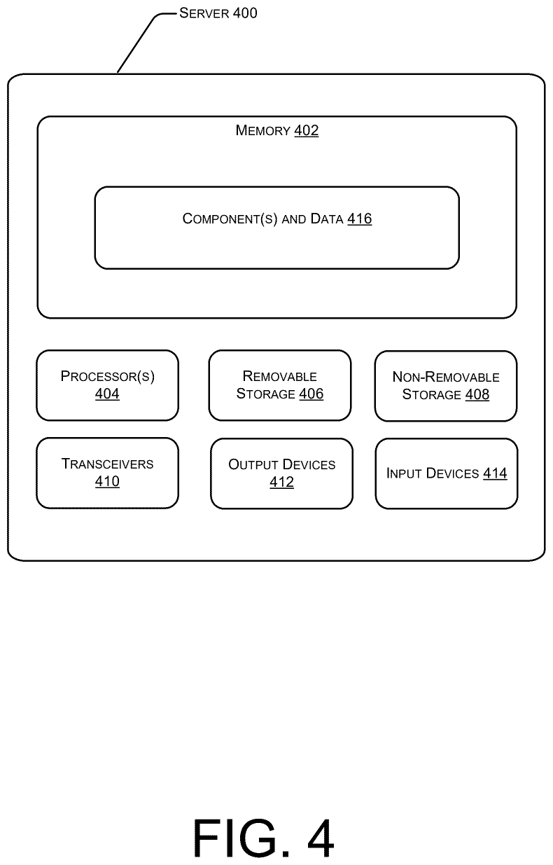

FIG. 4 schematically illustrates a component level view of a server 400 configured for use within a wireless communication network, e.g., wireless communication network 100, in order to provide various services within the wireless communication network, according to the techniques described herein. For example, the server 400 may serve as the network controller 110, e.g., one or more servers 400 may be configured to serve the network controller 110. As another example, the server 400 may serve as a PGW 114, e.g., one or more servers 400 may be configured to serve as a PGW 114, and/or the server 400 may serve as a UPF 116, e.g., one or more servers 400 may be configured to serve as a UPF 116.

As illustrated, the server 400 comprises a system memory 402 that may store one or more components and/or applications and data 416 for interacting with mobile communication devices, e.g., mobile communication device 102, as described herein. Also, the server 400 may include processor(s) 404, a removable storage 406, a non-removable storage 408, transceivers 410, output device(s) 412, and input device(s) 414.

In various implementations, system memory 402 is volatile (such as RAM), non-volatile (such as ROM, flash memory, etc.), or some combination of the two. In some implementations, the processor(s) 404 is a Central Processing Unit (CPU), a Graphics Processing Unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 406 and non-removable storage 408. The one or more of the memory 402, the removable storage 406 and/or the non-removable storage 408 may include module(s) and data 416 (illustrated in the memory 402). The module(s) and data 416 may include instructions executable by, for example, the processor(s) 404.

Non-transitory computer-readable media may include volatile and nonvolatile, removable and non-removable tangible, physical media implemented in technology for storage of information, such as computer readable instructions, data structures, program modules, or other data. System memory 402, removable storage 406 and non-removable storage 408 are all examples of non-transitory computer-readable media. Non-transitory computer-readable media include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 410 include any sort of transceivers known in the art. For example, the transceivers 410 may include wired communication components, such as an Ethernet port, for communicating with other networked devices. Also, or instead, the transceivers 410 may include wireless modem(s) to facilitate wireless connectivity with other computing devices. Further, the transceivers 410 may include a radio transceiver that performs the function of transmitting and receiving radio frequency communications via an antenna.

In some implementations, the output devices 412 include any sort of output devices known in the art, such as a display (e.g., a liquid crystal display), speakers, a vibrating mechanism, or a tactile feedback mechanism. Output devices 412 also include ports for one or more peripheral devices, such as headphones, peripheral speakers, or a peripheral display.

In various implementations, input devices 414 include any sort of input devices known in the art. For example, input devices 414 may include a camera, a microphone, a keyboard/keypad, a computer mouse, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1 and 2. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
collecting, by a controller within a wireless communication network from at least one source within the wireless communication network, data related to total traffic within the wireless communication network;
classifying, by the controller, the data based on radio access technology (RAT) type;
based at least in part on the RAT type, identifying, by the controller, an amount of traffic of the total traffic attributable to fifth generation (5G) stand-alone (SA) RAT type;
determining, by the controller, a 5G SA utilization metric, wherein determining the 5G SA utilization metric comprises dividing the total traffic by the amount of traffic attributable to the 5G SA RAT type; and
based at least in part on the 5G SA utilization metric, evaluating one or more 5G SA focus areas.

2. The method of claim 1, wherein the at least one source comprises one or more of (i) a packet data network gateway (PGW) of the wireless communication network or (ii) a user plane function (UPF) of the wireless communication network.

3. The method of claim 1, wherein the one or more 5G SA focus areas comprise optimization of national 5G SA utilization.

4. The method of claim 1, wherein the one or more 5G SA focus areas comprise mobile device vendor 5G SA utilization.

5. The method of claim 1, wherein the one or more 5G SA focus areas comprise mobile device operating system (OS) 5G SA utilization.

6. The method of claim 1, wherein the one or more 5G SA focus areas comprise mobile device design.

7. The method of claim 1, wherein the one or more 5G SA focus areas comprise 5G SA deployment within the wireless communication network.

8. The method of claim 1, wherein the one or more 5G SA focus areas comprise identifying one or more network inefficiencies or one or more mobile device inefficiencies.

9. The method of claim 1, wherein the one or more 5G SA focus areas comprise guiding targeted upgrade strategies within the wireless communication network.

10. A system comprising:
one or more processors; and
one or more non-transitory computer-readable media storing computer-executable instructions that, when executed by the one or more processors, cause the one or more processors to perform actions comprising:
collecting, by a controller within a wireless communication network from at least one source within the wireless communication network, data related to total traffic within the wireless communication network;
classifying, by the controller, the data based on radio access technology (RAT) type;
based at least in part on the RAT type, identifying, by the controller, an amount of traffic of the total traffic attributable to fifth generation (5G) stand-alone (SA) RAT type;
determining, by the controller, a 5G SA utilization metric, wherein determining the 5G SA utilization metric comprises dividing the total traffic by the amount of traffic attributable to the 5G SA RAT type; and
based at least in part on the 5G SA utilization metric, evaluating one or more 5G SA focus areas.

11. The system of claim 10, wherein the at least one source comprises one or more of (i) a packet data network gateway (PGW) of the wireless communication network or (ii) a user plane function (UPF) of the wireless communication network.

12. The system of claim 10, wherein the one or more 5G SA focus areas comprise optimization of national 5G SA utilization.

13. The system of claim 10, wherein the one or more 5G SA focus areas comprise mobile device vendor 5G SA utilization.

14. The system of claim 10, wherein the one or more 5G SA focus areas comprise mobile device operating system (OS) 5G SA utilization.

15. The system of claim 10, wherein the one or more 5G SA focus areas comprise mobile device design.

16. The system of claim 10, wherein the one or more 5G SA focus areas comprise 5G SA deployment within the wireless communication network.

17. The system of claim 10, wherein the one or more 5G SA focus areas comprise identifying one or more network inefficiencies or one or more mobile device inefficiencies.

18. The system of claim 10, wherein the one or more 5G SA focus areas comprise guiding targeted upgrade strategies within the wireless communication network.

19. One or more non-transitory computer-readable media storing computer-executable instructions that, when executed by one or more processors, cause the one or more processors to perform actions comprising:
collecting, by a controller within a wireless communication network from at least one source within the wireless communication network, data related to total traffic within the wireless communication network;
classifying, by the controller, the data based on radio access technology (RAT) type;
based at least in part on the RAT type, identifying, by the controller, an amount of traffic of the total traffic attributable to fifth generation (5G) stand-alone (SA) RAT type;
determining, by the controller, a 5G SA utilization metric, wherein determining the 5G SA utilization metric comprises dividing the total traffic by the amount of traffic attributable to the 5G SA RAT type; and
based at least in part on the 5G SA utilization metric, evaluating one or more 5G SA focus areas.

20. The one or more non-transitory computer-readable media of claim 19, wherein the at least one source comprises one or more of (i) a packet data network gateway (PGW) of the wireless communication network or (ii) a user plane function (UPF) of the wireless communication network.
